(19) United States
(12) Patent Application Publication
(10) Pub. No.: US 2026/0228018 A1
(43) Pub. Date: Aug. 6, 2026

(54) CONTROL PROCESSOR BASED CENTRAL PROCESSING UNIT (CPU) CORE ENABLEMENT FOR FASTER COLD/QUICK BOOT

(71) Applicant: QUALCOMM Incorporated, San Diego, CA (US)

(72) Inventors: Dinesh Kumar CHOUDHARY, Tonk (IN); Maulik SHAH, Hyderabad (IN)

(21) Appl. No.: 19/047,524

(22) Filed: Feb. 6, 2025

(51) Int. Cl. G06F 9/4401

(52) U.S. Cl. CPC G06F 9/4418

(57) ABSTRACT

A processor-implemented method of control processor based central processing unit (CPU) cores for faster cold/quick boot includes executing a cold boot process for a primary processor of multiple processors. The primary processor and cluster components firmware for supporting the multiple processors are enabled. A set of secondary processors of the multiple processors is enabled for software instruction fetching. The set of secondary processors of the multiple processors is configured to start execution of software instructions from a temporary wrapper.

### BACKGROUND

### Field

Aspects of the present disclosure relate to computing devices, and more specifically to control processor based central processing unit (CPU) cores for faster cold/quick boot.

### BACKGROUND

Mobile or portable computing devices include mobile phones, laptop, palmtop and tablet computers, portable digital assistants (PDAs), portable game consoles, and other portable electronic devices. Mobile computing devices are comprised of many electrical components that consume power and generate heat. The components (or compute devices) may include system-on-a-chip (SoC) devices, graphics processing unit (GPU) devices, neural processing unit (NPU) devices, digital signal processors (DSPs), and modems, among others.

The mobile computing devices may be configured with multiple processors to increase processing speed and efficiency. However, when the mobile computing devices boot-up with multiple processors, because of different requirements across different ecosystem and specifications, only the boot core may be enabled until the kernel is up and running and intermittently to parallelize boot-up. That is, other cores may be brought up but are turned off when execution moves to next stages in the boot-up process.

Central processing units (CPUs) and multiple processor core clusters are becoming more complex, including embedded features for power, performance, and security. The increased complexity may utilize significantly more firmware and result in increased latency in routines for booting the cores. As a result, boot-up time for devices configured with such multiple processor core clusters may be increased and may directly impact the device's specifications for cold boot and quick boot key performance indicators (KPIs).

### SUMMARY

Various aspects of the present disclosure are directed to an apparatus. The apparatus has at least one memory and one or more processors coupled to the at least one memory. The processor(s) is configured to execute a cold boot process for a primary processor of multiple processors. The processor(s) is also configured to enable the primary processor and cluster components firmware for supporting the multiple processors. The processor(s) is additionally configured to enable a set of secondary processors of the multiple processors for software instruction fetching. The processor(s) is further configured to configure the set of secondary processors of the multiple processors to start execution of software instructions from a temporary wrapper.

In some aspects of the present disclosure, a processor-implemented method includes executing a cold boot process for a primary processor of multiple processors. The processor-implemented method also includes enabling the primary processor and cluster components firmware for supporting the multiple processors. The processor-implemented method additionally includes enabling a set of secondary processors of the multiple processors for software instruction fetching. The processor-implemented method further includes configuring the set of secondary processors of the multiple processors to start execution of software instructions from a temporary wrapper.

Various aspects of the present disclosure are directed to an apparatus. The apparatus includes means for executing a cold boot process for a primary processor of multiple processors. The apparatus also includes means for enabling the primary processor and cluster components firmware for supporting the multiple processors. The apparatus additionally includes means for enabling a set of secondary processors of the multiple processors for software instruction fetching. The apparatus further includes means for configuring the set of secondary processors of the multiple processors to start execution of software instructions from a temporary wrapper.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 illustrates an example implementation of a host system-on-a-chip (SoC), including a boot sequence for enablement of multi-core processors, in accordance with certain aspects of the present disclosure.

FIG. 2 is a block diagram illustrating a multi-core cluster architecture 200, in accordance with various aspects of the present disclosure.

FIG. 3 is a diagram illustrating an adapted multi-core boot sequence, in accordance with various aspects of the present disclosure.

FIG. 4 is a block diagram illustrating a multi-core boot sequence in accordance with various aspects of the present disclosure.

FIG. 5 is a block diagram illustrating a device boot sequence, in accordance with various aspects of the present disclosure.

FIG. 6 is a flow diagram illustrating an example process performed, for example, by a mobile or wearable device, in accordance with various aspects of the present disclosure.

FIG. 7 is a block diagram showing an exemplary wireless communications system in which a configuration of the present disclosure may be advantageously employed.

FIG. 8 is a block diagram illustrating a design workstation used for circuit, layout, and logic design of components, in accordance with various aspects of the present disclosure.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. It will be apparent, however, to those skilled in the art that these concepts may be practiced without these specific details. In some instances, well-known structures and components are shown in block diagram form in order to avoid obscuring such concepts.

As described, the use of the term “and/or” is intended to represent an “inclusive OR,” and the use of the term “or” is intended to represent an “exclusive OR.” As described, the term “exemplary” used throughout this description means “serving as an example, instance, or illustration,” and should not necessarily be construed as preferred or advantageous over other exemplary configurations. As described, the term “coupled” used throughout this description means “connected, whether directly or indirectly through intervening connections (e.g., a switch), electrical, mechanical, or otherwise,” and is not necessarily limited to physical connections. Additionally, the connections can be such that the objects are permanently connected or releasably connected. The connections can be through switches. As described, the term “proximate” used throughout this description means “adjacent, very near, next to, or close to.” As described, the term “on” used throughout this description means “directly on” in some configurations, and “indirectly on” in other configurations.

Mobile computing devices may be configured with multiple processors to increase processing speed and efficiency. However, when the mobile computing devices boot-up with multiple processors, because of different requirements across different ecosystems and specifications, only the boot core may be enabled to parallelize until the kernel is up and running. Some conventional approaches may intermittently enable additional cores, but the additional cores have to be disabled (e.g., turned off) prior to handoff to the next execution level (e.g., between different boot loaders) in the boot-up process.

With central processing units (CPUs) and multiple processor core clusters evolving to be more complex and many features embedded for power, performance, and security, core bring-up may have higher latency routines with significantly more firmware and hardware involved.

To enable the complexities of and enhanced power, performance, and security features, boot-up time may increase and may directly impact the device's specifications for cold boot and quick boot key performance indicators (KPIs).

Accordingly, to address these and other challenges, aspects of the present disclosure are directed to enabling multiple processing cores for boot-up.

Particular aspects of the subject matter described in this disclosure can be implemented to realize one or more of the following potential advantages. In some examples, the described techniques, such as enabling multiple processing cores for boot-up (e.g., configuring a set of secondary processors of multiple processors to start execution of the software instructions from a temporary wrapper) may enable reduced latency when enabling multi-core processors and increased availability of multi-core processors.

Aspects of the present disclosure may be broadly applicable with example use-cases including automotive systems and wearables devices, for instance.

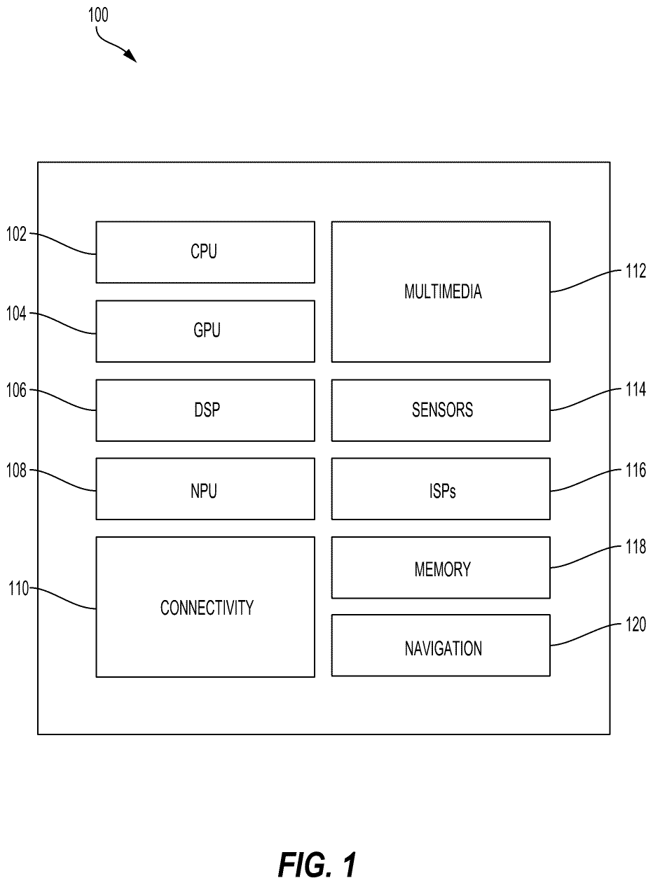

FIG. 1 illustrates an example implementation of a host system-on-a-chip (SoC) 100, which includes a boot sequence for enablement of multi-core processors, in accordance with aspects of the present disclosure. The host SoC 100 includes processing blocks tailored to specific functions, such as a connectivity block 110. The connectivity block 110 may include fifth generation (5G) connectivity, fourth generation long term evolution (4G LTE) connectivity, Wi-Fi connectivity, universal serial bus (USB) connectivity, Bluetooth® connectivity, Secure Digital (SD) connectivity, and the like.

In this configuration, the host SoC 100 includes various processing units that support multi-threaded operation. For the configuration shown in FIG. 1, the host SoC 100 includes a multi-core central processing unit (CPU) 102, a graphics processor unit (GPU) 104, a digital signal processor (DSP) 106, and a neural processor unit (NPU) 108. The host SoC 100 may also include a sensor processor 114, image signal processors (ISPs) 116, a navigation module 120, which may include a global positioning system (GPS), and a memory 118. The multi-core CPU 102, the GPU 104, the DSP 106, the NPU 108, and the multi-media engine 112 support various functions such as video, audio, graphics, gaming, artificial networks, and the like. Each processor core of the multi-core CPU 102 may be a reduced instruction set computing (RISC) machine, an advanced RISC machine (ARM), a microprocessor, or some other type of processor. The NPU 108 may be based on an ARM instruction set.

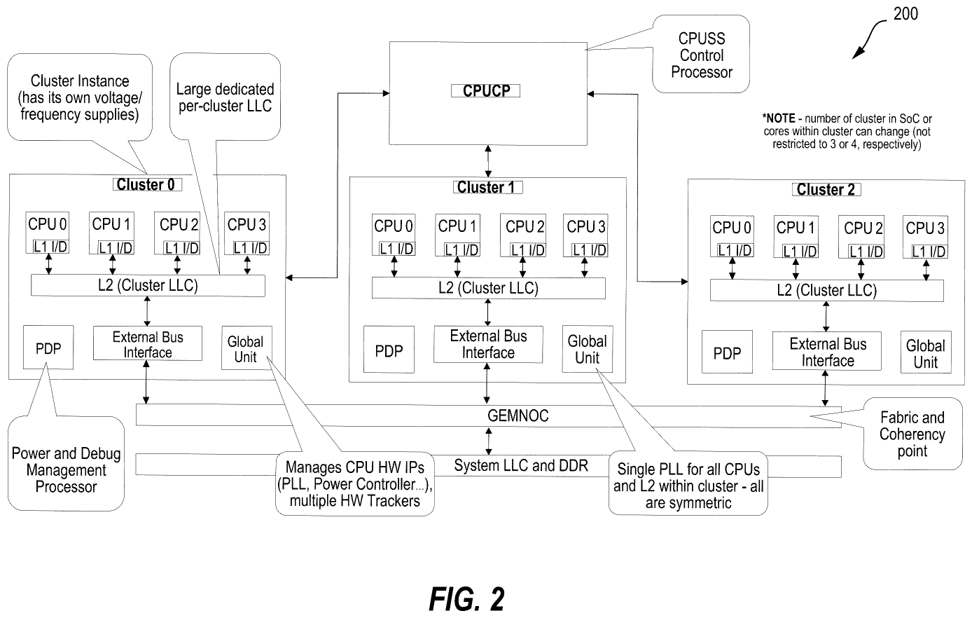

FIG. 2 is a block diagram illustrating a multi-core cluster architecture 200, in accordance with various aspects of the present disclosure. The multi-core cluster architecture 200 includes a CPU subsystem (CPUSS) control processor (CPUCP) that communicates with each cluster (cluster 0, cluster 1, cluster 2). It is noted that the number of clusters within an SoC and the number of cores within a cluster is not restricted to three or four, as seen in the example of FIG. 2. Each cluster (cluster 0,cluster 1, cluster 2) includes multiple cores (CPU 0, CPU 1, CPU 2, CPU 3) and a last level two last level cache L2 LLC for the entire cluster. Each cluster (cluster 0, cluster 1, cluster 2) has its own voltage and frequency supplies, as well as a power and debug management processor (PDP). Global units within each cluster (cluster 0, cluster 1, cluster 2) include a phase lock loop (PLL) for all CPUs and the cache within each cluster. The global unit manages CPU hardware (HW) blocks (e.g., IPs) including a phase lock loop (PLL), power controller, activity monitor unit (AMU), performance monitor unit (PMU), and other hardware trackers. An external bus interface within each cluster (cluster 0, cluster 1, cluster 2) communicates with a fabric and coherency point gladiator and memory network-on-chip (GEMNOC). The fabric and coherency point (GEMNOC) communicates with a system last level cache and DDR memory.

Aspects of the present disclosure are directed to a boot sequence for enablement of multi-core processors in cold and quick boot of multi-core processors.

According to aspects of the present disclosure, a mobile device includes means for executing a cold boot process for a primary processor of multiple processors; means for enabling the primary processor and cluster components firmware for supporting the multiple processors; means for enabling a set of secondary processors of the multiple processors for software instruction fetching; and means for configuring the set of secondary processors of the multiple processors to start execution of software instructions from a temporary wrapper. In one configuration, the means for executing, the means for enabling the primary processor and cluster components firmware, the means for enabling a set of secondary processors, and/or the means for configuring may be the CPUCP, global units, or GEMNOC, for example, as shown in FIG. 2. In other aspects, the aforementioned means may be any structure or any material configured to perform the functions recited by the aforementioned means.

In the conventional multi-core boot sequence, a boot-core issues a CPU_ON secure monitor call (SMC) for secondary cores on a one-by-one basis at the kernel level. The boot core starts bringing up cores one-by-one from a reset, via a power state coordination interface (PSCI) recommendation by providing a target number of CPUs and entry addresses and issues a system SMC call. The SMC call enables communication between different execution levels (e.g., between kernel level (non-secure) and trusted zone). In the kernel level, only the boot core may be powered on, while all other cores are powered off or in reset mode. The kernel runs in a non-secure execution level.

Next, the conventional multi-core boot sequence proceeds to the hypervisor level. A hypervisor may refer to software that creates and runs virtual machines on a host computer. The hypervisor may separate the operating system (e.g., kernel) and resources from the physical host computer, and instead allocates the resources of the host computer among multiple virtual machines. The hypervisor may trap the SMC call and save the entry addresses, as well as any virtual-to-physical mapping translation and further issues an SMC call to a trusted zone (TZ). The hypervisor may prepare secondary cores for enablement and issues an SMC call to the TZ. A TZ may comprise a secure execution environment that includes only network objects that are trusted. The TZ may be generated by trusted firmware.

Control of the conventional multi-core boot sequence may proceed to the trusted firmware level. The trusted firmware may sanitize core enablement routines. For instance, the hypervisor may validate the parameters of the SMC call (e.g., SMC call previously issued) and may check whether a core may be enabled per hardware routines/specifications. The trusted firmware may update the local structures and issue a system and control management interface (SCMI) call to a central processing unit control processor (CPUCP). SCMI may refer to a set of operating system-independent software interfaces that may be described in firmware for system management such as power domain management, performance management, or clock management, for example. SCMI may enable an operating system to manage various functions provided by the hardware platform on which the operating system is operating.

The conventional multi-core boot sequence may execute the firmware for the CPUCP (“CPUCP firmware”) for a CPU subsystem (e.g., cluster). The CPUCP firmware is executed per CPU subsystem. The CPUCP firmware may enable voltage and frequency supplies for each cluster. The CPUCP firmware may then enable the clusters. The CPUCP firmware may also load the cluster firmware for a power and debug management processor (PDP) into a memory (e.g., a flash memory) and may enable the PDP. Furthermore, the firmware for the CPUCP may poll the PDP to determine whether booting is complete (e.g., a cookie may provide an indication that the boot is complete). When the PDP booting is completed, the CPUCP firmware may be perform secondary core system initialization programming (e.g., enabling cache or configuration and status register (CSR)) for a next core in the cluster. Thereafter, for each of the secondary cores, the CPUCP firmware may only perform the system initialization (sysini) programming.

The conventional multi-core boot sequence may execute the PDP firmware (may also referred to as “cluster firmware”). The cluster firmware is cluster-specific and may be executed on a per cluster basis. That is, each cluster has different firmware. The cluster firmware is responsible for cluster power management. The CPUCP loads the PDP firmware image and asserts requests for bring-up to start a PDP cold boot and initialize dynamic clock and voltage scaling (DCVS) limits and debug infrastructure routines. DCVS controls clock frequency and voltage level settings for each core in the multi-core cluster. Furthermore, the cluster firmware may initialize cluster resources such as power rail and phase-locked loops as well as SoC-specific routines (e.g., aging, calibration, etc.) and may update the boot cookie to be performed.

Once the PDP is up and running, the CPUCP configures a core-specific initialization register space. Software fetching may be enabled on a secondary core and the secondary core may start executing. A response to the SCMI call may be communicated to the TZ. For instance, the enablement of the secondary core may be communicated to the trusted firmware. The boot core may also receive a response indicating that the secondary core is about to start the software execution and may return to the hypervisor status updates for the secondary core enablement. Then, the boot core returns to the kernel and starts the sequencing for remaining secondary cores.

The secondary core may start executing from a reset vector base address and may prepare its context for the trusted firmware in execution level 3(EL3) and in secure execution level 1 (sec-EL1). The secondary core start procedure may be started in parallel with the notification to the boot core indicating that the secondary core is about to start the software execution.

The secondary core may start executing from a hypervisor entry address and prepares its context for interrupt requests (IRQs) or debugs and other related functionalities (e.g., configuration for non-secure (NS) execution level 2(EL2)). Then, at the kernel level, the secondary core may start executing at the entry address and sets up a kernel stack. Thereafter, the secondary core may repeatedly return to the kernel level and the secondary core may intermittently be available for scheduling activities.

For each additional secondary core, the secondary core system initialization programming (of the CPUCP firmware), the cluster firmware, and the loopback communication between the TZ to the hypervisor to the kernel, and the secondary core execution start-up are performed. Furthermore, between execution levels, only the boot core may operate. In other word, the CPUCP asserts PDP bring-up request and completes other sysini routines until there are settings for which the PDP has to be fully up and running and explicitly waits for PDP boot-up complete (e.g., indicated by a boot cookie). Thus, significant time may be expended in the firmware for the CPUCP and the cluster firmware, which may result in delays in booting.

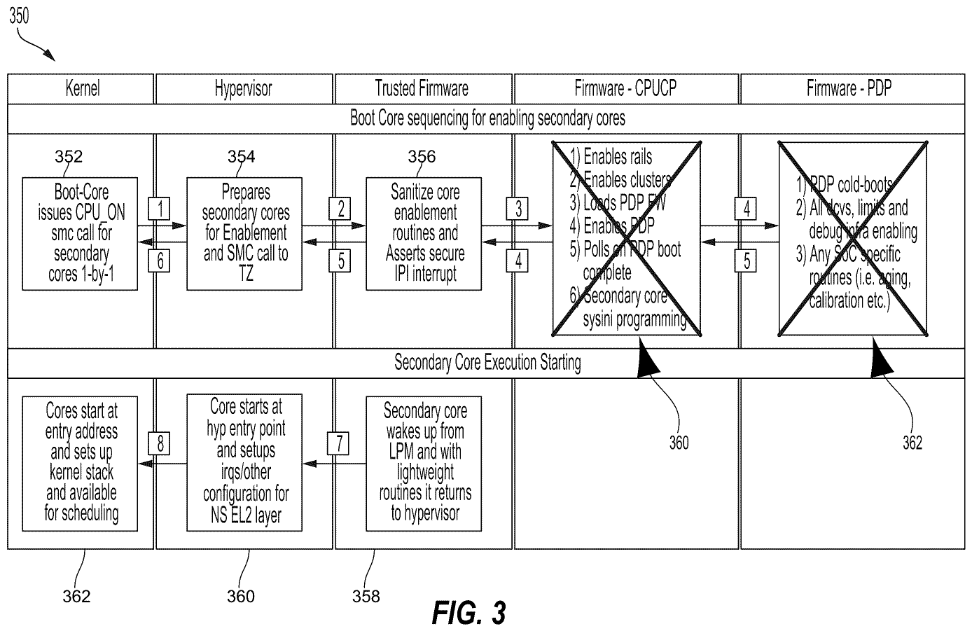

FIG. 3 is a diagram illustrating an adapted multi-core boot sequence 350, in accordance with various aspects of the present disclosure. Referring to FIG. 3, in the adapted multi-core boot sequence 350, at block 352, at the kernel level, the boot core starts booting up cores of a multi-core cluster one-by-one from reset, via a PSCI recommendation by providing a target number (e.g., an identification register value for a processor in a multiprocessor system (MPIDR)) of CPUs and entry addresses, and issues an SMC call.

Next, the adapted multi-core boot sequence 350 moves to the hypervisor level. At block 354, the hypervisor may prepare secondary cores for enablement and issue an SMC call to the trusted zone (TZ).

Control of the adapted multi-core boot sequence 350 may proceed to the trusted firmware level. At block 356, the trusted firmware may sanitize core enablement routines. For instance, the hypervisor may validate the parameters of the SMC call (e.g., SMC call issued in block 354) and may check whether a core may be enabled per hardware routines/specifications. However, because the secondary cores are in the low power mode (LPM) and the CPU_ON is not performed, the trusted firmware may assert a secure inter-processor interrupt (IPI), which may wake a core from LPM. An IPI refers to a special type of interrupt by which one processor may interrupt another processor in a multi-processor computing system. Accordingly, the latency in making the secondary cores available for software instruction fetching may be reduced. That is, relative to the conventional muti-core boot sequence, the procedures of the CPUCP firmware and the PDP firmware may not be performed (e.g., may be avoided as illustrated by X over elements 360 and 362, respectively).

Thereafter, the boot core may return to the kernel level, at block 352, to start sequencing for the remaining secondary cores. Then, at block 358, the secondary core may wake up from LPM and with lightweight routines returns to the hypervisor level. That is, complex routines like cluster firmware enablement etc. may be performed before and at the moment a core exits LPM, which may be much faster than core bringing up a core out of a reset. The secondary core may start executing from a temporary wrapper in sec-EL1. The secondary core may immediately return to the hypervisor level with minimal lightweight routines in the trusted firmware because the entire secure context is already constructed in parallel with the device boot, which may start in parallel with waking of the secondary cores from LPM.

At block 360, the secondary core may start executing from a hypervisor entry point and may set-up IRQs and other configurations for non-secure EL2. At block 362, at the kernel level, the enabled cores may start executing from an entry address and set up the kernel stack. Thereafter, the secondary core may return to the kernel level and the secondary core may be available for scheduling activities.

Accordingly, overhead of the conventional multi-core boot sequence due to boot core enablement may be reduced. Additionally, overhead due to enabling the secondary cores from a reset vector base address may also be reduced. In doing so, latency with respect to multi-core enablement may be reduced.

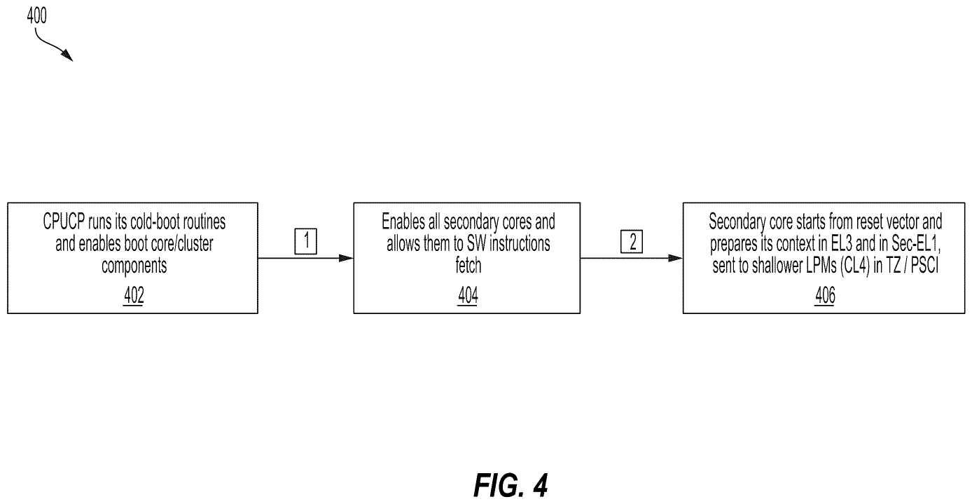

FIG. 4 is a block diagram illustrating a multi-core boot sequence 400 in accordance with various aspects of the present disclosure. As shown in FIG. 4, at block 402, the multi-core boot sequence 400 provides that a CPUCP executes cold boot routines and enables boot core or cluster components. The cold boot routines may be executed in parallel with boot core execution of an extended boot loader for the trusted firmware and hypervisor cold boot. That is, the CPUCP may enable the secondary core independently without a request from the boot core (e.g., application processor core).

At block 404, multiple secondary cores, and in some aspects all secondary cores, may be enabled such that the enabled secondary cores may perform software (SW) instruction fetching. That is, in trusted firmware, the enabled secondary cores may be running without a CPU_ON request.

At block 406, the secondary cores may start from a reset vector and prepare context in EL3 and in sec-EL1, and send to shallower low power modes (LPMs) (e.g., deep sleep (DS) or cluster power gating level 4 (CL4)) in the TZ in PSCI with exit latencies (e.g., ~200 μs) (which may be further reduced by additional LPMs). In DS state N-1 cores may power off, with a last core and chip power rail remaining active. In CL4, the cluster logic (e.g., cache and cores) may be power-gated. Phase locked loops (PLLs) and power rails continue to drive the clock, but no clients are using the clock. Then, when scheduled for activity, the secondary cores may exit the LPM and begin executing software instructions.

Accordingly, aspects of the present disclosure may beneficially reduce boot-up time of multi-core processors and reduce latency with respect to availability of cores. Moreover, aspects of the present disclosure may enable increased flexibility of SoC-specific feature incorporation with reduced impact to boot key performance indicators (KPIs).

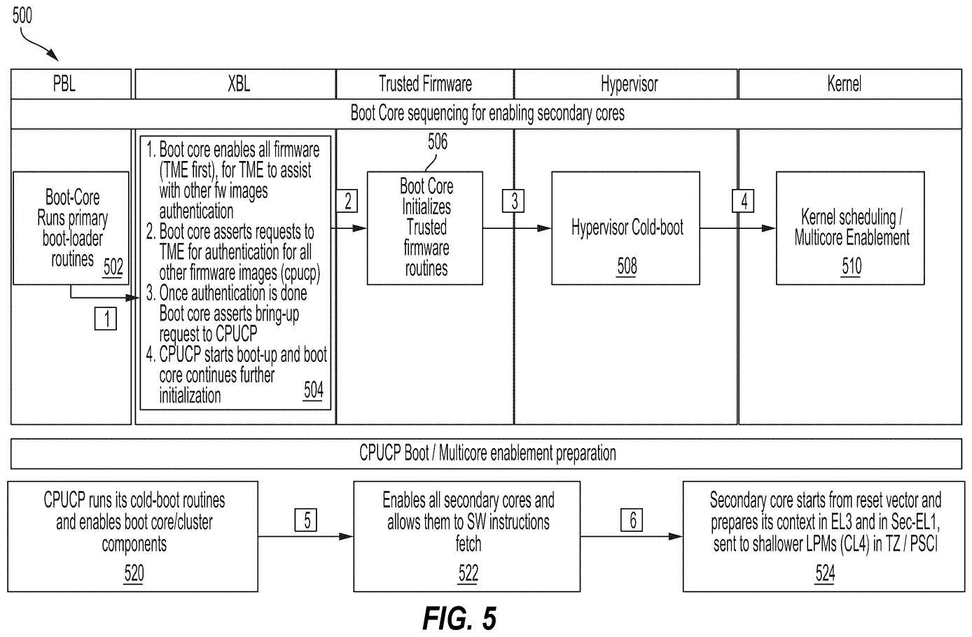

FIG. 5 is a block diagram illustrating a device boot sequence 500, in accordance with various aspects of the present disclosure. Referring to FIG. 5, at block 502, a boot core may execute primary boot loader (PBL) routines.

At block 504, a boot core (e.g., an application processor) execute eXtensible boot loader (XBL) routines. The boot core may enable firmware such as a trust management engine (TME) firmware to authenticate other firmware. For instance, the boot core may assert requests to the TME for authentication of CPUCP firmware images. After authenticating the other firmware images, the boot core may assert boot requests to the CPUCP. In turn, the CPUCP may begin a boot-up process. In the CPUCP multi-core enablement preparation, at block 520, the CPUCP may run cold boot routines and may enable boot core/cluster components.

At block 506, the boot core may, at the trusted firmware level, initialize trusted firmware routines. Then, at the hypervisor level, at block 508, the hypervisor may be cold-booted and system management-related settings may be initialized. Then, at the kernel level, at block 510, the boot core may move to the kernel to enable the multi-core scheduling of the cores for execution.

Concurrently, at block 522, all of the secondary cores may be enabled for software instruction fetching. Thereafter, at the TZ level, at block 524, the secondary cores may start from a reset vector and may be placed in LPM (e.g., DS or CL4) until scheduled for activity in block 510.

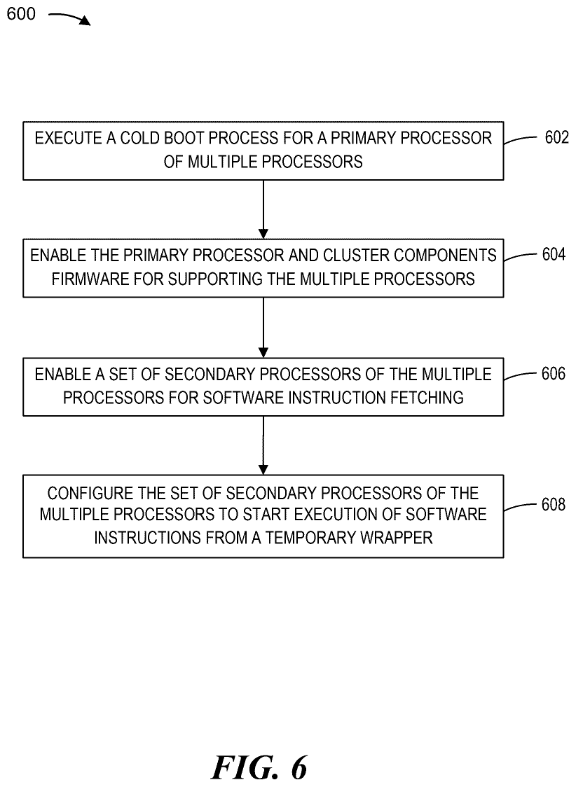

FIG. 6 is a flow diagram illustrating an example process 600 performed, for example, by a mobile or wearable device, in accordance with various aspects of the present disclosure. The example process 600 is an example of multi-core enablement.

As shown in FIG. 6, at block 602, the process 600 may include executing a cold boot process for a primary processor of multiple processors. For example, as described with reference to FIG. 4, the multi-core boot sequence 400 provides that a CPUCP executes cold boot routines. The cold boot routines may be executed in parallel with boot core execution of an extended boot loader for the trusted firmware and hypervisor cold boot. The CPUCP may enable the secondary core independently without a request from the boot core (e.g., application processor core).

At block 604, the process 600 includes enabling the primary processor and cluster components firmware for supporting the multiple processors. For instance, as described with reference to FIG. 4, the CPUCP enables boot core or cluster components.

At block 606, the process 600 includes enabling a set of secondary processors of the multiple processors for software instruction fetching. As described, for example, with reference to FIG. 4, multiple secondary cores, and in some aspects all secondary cores, may be enabled such that the enabled secondary cores may perform software (SW) instruction fetching. That is, in trusted firmware, the enabled secondary cores may be running without a CPU_ON request.

At block 608, the process 600 includes configuring the set of secondary processors of the multiple processors to start execution of software instructions from a temporary wrapper. For example, as described with respect to FIG. 4, the secondary cores may start from a reset vector and prepare context in EL3 and in sec-EL1, and send to shallower low power modes (LPMs) (e.g., deep sleep or cluster power gating level 4 (CL4)) in the TZ in PSCI with exit latencies (e.g., ~200 μs) (which may be further reduced by additional LPMs). In CL4, the cluster logic (e.g., cache and cores) may be power-gated. Phase locked loops (PLLs) and power rails continue to drive the clock, but no clients are using the clock. Then, when scheduled for activity, the secondary cores may exit the LPM and begin executing software instructions.

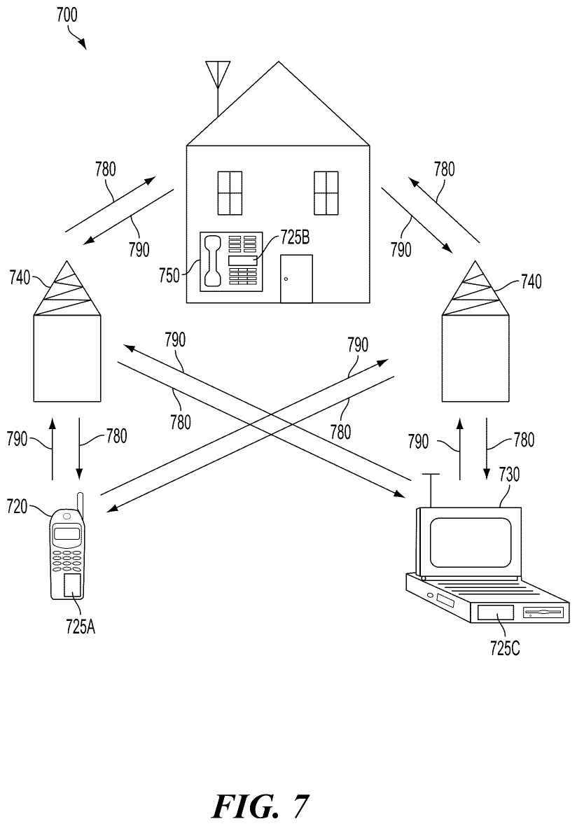

FIG. 7 is a block diagram showing an exemplary wireless communications system 700, in which an aspect of the present disclosure may be advantageously employed. For purposes of illustration, FIG. 7 shows three remote units 720, 730, and 750, and two base stations 740. It will be recognized that wireless communications systems may have many more remote units and base stations. Remote units 720, 730, and 750 include integrated circuit (IC) devices 725A, 725B, and 725C that include the disclosed multi-core enablement process. It will be recognized that other devices may also include the disclosed multi-core enablement process, such as the base stations, switching devices, and network equipment. FIG. 7 shows forward link signals 780 from the base stations 740 to the remote units 720, 730, and 750, and reverse link signals 790 from the remote units 720, 730, and 750 to the base stations 740.

In FIG. 7, remote unit 720 is shown as a mobile telephone, remote unit 730 is shown as a portable computer, and remote unit 750 is shown as a fixed location remote unit in a wireless local loop system. For example, the remote units may be a mobile phone, a hand-held personal communication systems (PCS) unit, a portable data unit, such as a personal data assistant, a GPS enabled device, a navigation device, a set top box, a music player, a video player, an entertainment unit, a fixed location data unit, such as meter reading equipment, or other device that stores or retrieves data or computer instructions, or combinations thereof. Although FIG. 7 illustrates remote units according to the aspects of the present disclosure, the disclosure is not limited to these exemplary illustrated units. Aspects of the present disclosure may be suitably employed in many devices, which include the disclosed multi-core enablement process.

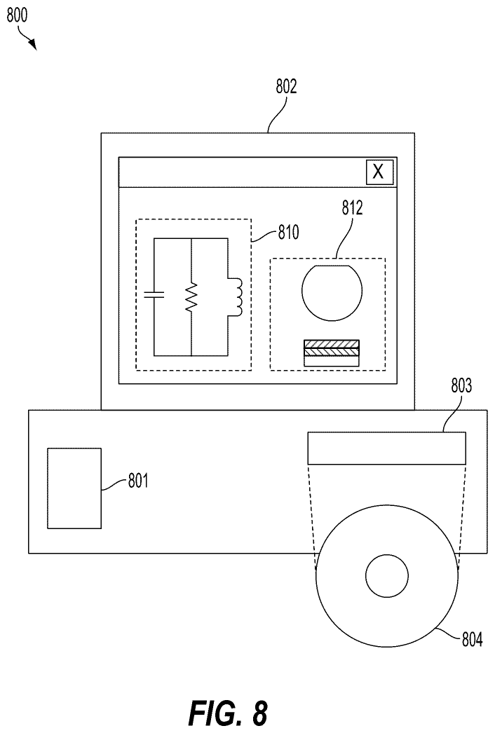

FIG. 8 is a block diagram illustrating a design workstation 800 used for circuit, layout, and logic design of a semiconductor component, such as the multi-core enablement process disclosed above. The design workstation 800 includes a hard disk 801 containing operating system software, support files, and design software such as Cadence or OrCAD. The design workstation 800 also includes a display 802 to facilitate design of a circuit 810 or a semiconductor component 812, such as the multi-core enablement process. A storage medium 804 is provided for tangibly storing the design of the circuit 810 or the semiconductor component 812 (e.g., the PLD). The design of the circuit 810 or the semiconductor component 812 may be stored on the storage medium 804 in a file format such as GDSII or GERBER. The storage medium 804 may be a CD-ROM, DVD, hard disk, flash memory, or other appropriate device. Furthermore, the design workstation 800 includes a drive apparatus 803 for accepting input from or writing output to the storage medium 804.

Data recorded on the storage medium 804 may specify logic circuit configurations, pattern data for photolithography masks, or mask pattern data for serial write tools such as electron beam lithography. The data may further include logic verification data such as timing diagrams or net circuits associated with logic simulations. Providing data on the storage medium 804 facilitates the design of the circuit 810 or the semiconductor component 812 by decreasing the number of processes for designing semiconductor wafers.

### Example Aspects

Aspect 1: An apparatus, comprising: at least one memory; and multiple processors coupled to the at least one memory, at least one processor of the multiple processors being configured to: execute a cold boot process for a primary processor of the multiple processors; enable the primary processor and cluster components firmware for supporting the multiple processors; enable a set of secondary processors of the multiple processors for software instruction fetching; and configure the set of secondary processors of the multiple processors to start execution of software instructions from a temporary wrapper.
Aspect 2: The apparatus of Aspect 1, in which the at least one processor is configured to execute the cold boot process concurrently with execution of an extended boot loader for authentication for firmware images and initialization of trusted firmware routines by the primary processor.
Aspect 3: The apparatus of Aspect 1 or 2, in which the temporary wrapper comprises a low power mode.
Aspect 4: The apparatus of any preceding Aspect, in which the at least one processor is configured to: wake the set of secondary processors from the low power mode; and schedule execution of software instructions by at least one secondary processor of the set of secondary processors.
Aspect 5: The apparatus of any preceding Aspect, in which the set of secondary processors are configured to wake from the low power mode in response to a secure inter-processor interrupt (IPI).
Aspect 6: The apparatus of any preceding Aspect, in which the cluster components firmware comprises power and clock management for the set of secondary processors.
Aspect 7: The apparatus of any preceding Aspect, in which the at least one processor enables the set of secondary processors independently without a request from the primary processor.
Aspect 8: A processor-implemented method performed by one or more processors, the processor-implemented method comprising: executing a cold boot process for a primary processor of multiple processors; enabling the primary processor and cluster components firmware for supporting the multiple processors; enabling a set of secondary processors of the multiple processors for software instruction fetching; and configuring the set of secondary processors of the multiple processors to start execution of software instructions from a temporary wrapper.
Aspect 9: The processor-implemented method of Aspect 8, further comprising executing the cold boot process concurrently with execution of an extended boot loader for authentication for firmware images and initialization of trusted firmware routines by the primary processor.
Aspect 10: The processor-implemented method of Aspect 8 or 9, in which the temporary wrapper comprises a low power mode.
Aspect 11: The processor-implemented method of any of Aspects 8-10, further comprising: waking the set of secondary processors from the low power mode; and scheduling execution of software instructions by at least one secondary processor of the set of secondary processors.
Aspect 12: The processor-implemented method of any of Aspects 8-11, in which the set of secondary processors are configured to wake from the low power mode in response to a secure inter-processor interrupt (IPI).
Aspect 13: The processor-implemented method of any of Aspects 8-12, in which the cluster components firmware comprises power and clock management for the set of secondary processors.
Aspect 14: The processor-implemented method of any of Aspects 8-13, further comprising enabling the set of secondary processors independently without a request from the primary processor.
Aspect 15: An apparatus, comprising: means for executing a cold boot process for a primary processor of multiple processors; means for enabling the primary processor and cluster components firmware for supporting the multiple processors; means for enabling a set of secondary processors of the multiple processors for software instruction fetching; and means for configuring the set of secondary processors of the multiple processors to start execution of software instructions from a temporary wrapper.
Aspect 16: The apparatus of Aspect 15, further comprising means for executing the cold boot process concurrently with execution of an extended boot loader for authentication for firmware images and initialization of trusted firmware routines by the primary processor.
Aspect 17: The apparatus of Aspect 15 or 16, in which the temporary wrapper comprises a low power mode.
Aspect 18: The apparatus of any of Aspects 15-17, further comprising: means for waking the set of secondary processors from the low power mode; and means for scheduling execution of software instructions by at least one secondary processor of the set of secondary processors.
Aspect 19: The apparatus of any of Aspects 15-18, in which the set of secondary processors are configured to wake from the low power mode in response to a secure inter-processor interrupt (IPI).
Aspect 20: The apparatus of any of Aspects 15-19, further comprising means for enabling the set of secondary processors independently without a request from the primary processor.

For a firmware and/or software implementation, the methodologies may be implemented with modules (e.g., procedures, functions, and so on) that perform the functions described. A machine-readable medium tangibly embodying instructions may be used in implementing the methodologies described. For example, software codes may be stored in a memory and executed by a processor unit. Memory may be implemented within the processor unit or external to the processor unit. As used, the term “memory” refers to types of long term, short term, volatile, nonvolatile, or other memory and is not limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include random access memory (RAM), read-only memory (ROM), electrically erasable read-only memory (EEPROM), compact disc read-only memory (CD-ROM) or other optical disk storage, magnetic disk storage or other magnetic storage devices, or other medium that can be used to store desired program code in the form of instructions or data structures and that can be accessed by a computer. Disk and disc, as used, include compact disc (CD), laser disc, optical disc, digital versatile disc (DVD), floppy disk, and Blu-ray® disc, where disks usually reproduce data magnetically, while discs reproduce data optically with lasers. Combinations of the above should also be included within the scope of computer-readable media.

In addition to storage on computer-readable medium, instructions and/or data may be provided as signals on transmission media included in a communications apparatus. For example, a communications apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions, and alterations can be made without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present disclosure is not intended to be limited to the particular configurations of the process, machine, manufacture, composition of matter, means, methods, and steps described in the specification. As one of ordinary skill in the art will readily appreciate from the present disclosure, processes, machines, manufacture, compositions of matter, means, methods, or steps, presently existing or later to be developed that perform substantially the same function or achieve substantially the same result as the corresponding configurations described may be utilized according to the present disclosure. Accordingly, the appended claims are intended to include within their scope such processes, machines, manufacture, compositions of matter, means, methods, or steps.

Those of skill would further appreciate that the various illustrative logical blocks, modules, circuits, and algorithm steps described in connection with the present disclosure may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure may be implemented or performed with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in RAM, flash memory, ROM, erasable programmable read-only memory (EPROM), EEPROM, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the present disclosure is provided to enable any person skilled in the art to make or use the present disclosure. Various modifications to the disclosure will be readily apparent to those skilled in the art, and the generic principles defined may be applied to other variations without departing from the spirit or scope of the disclosure. Thus, the present disclosure is not intended to be limited to the examples and designs described, but is to be accorded the widest scope consistent with the principles and novel features disclosed.

What is claimed is:

1. An apparatus, comprising:
at least one memory; and
multiple processors coupled to the at least one memory, at least one processor of the multiple processors being configured to:
execute a cold boot process for a primary processor of the multiple processors;
enable the primary processor and cluster components firmware for supporting the multiple processors;
enable a set of secondary processors of the multiple processors for software instruction fetching; and
configure the set of secondary processors of the multiple processors to start execution of software instructions from a temporary wrapper.

2. The apparatus of claim 1, in which the at least one processor is configured to execute the cold boot process concurrently with execution of an extended boot loader for authentication for firmware images and initialization of trusted firmware routines by the primary processor.

3. The apparatus of claim 1, in which the temporary wrapper comprises a low power mode.

4. The apparatus of claim 3, in which the at least one processor is configured to:
wake the set of secondary processors from the low power mode; and
schedule execution of software instructions by at least one secondary processor of the set of secondary processors.

5. The apparatus of claim 4, in which the set of secondary processors are configured to wake from the low power mode in response to a secure inter-processor interrupt (IPI).

6. The apparatus of claim 1, in which the cluster components firmware comprises power and clock management for the set of secondary processors.

7. The apparatus of claim 1, in which the at least one processor enables the set of secondary processors independently without a request from the primary processor.

8. A processor-implemented method performed by one or more processors, the processor-implemented method comprising:
executing a cold boot process for a primary processor of multiple processors;
enabling the primary processor and cluster components firmware for supporting the multiple processors;
enabling a set of secondary processors of the multiple processors for software instruction fetching; and
configuring the set of secondary processors of the multiple processors to start execution of software instructions from a temporary wrapper.

9. The processor-implemented method of claim 8, further comprising executing the cold boot process concurrently with execution of an extended boot loader for authentication for firmware images and initialization of trusted firmware routines by the primary processor.

10. The processor-implemented method of claim 8, in which the temporary wrapper comprises a low power mode.

11. The processor-implemented method of claim 10, further comprising:
waking the set of secondary processors from the low power mode; and
scheduling execution of software instructions by at least one secondary processor of the set of secondary processors.

12. The processor-implemented method of claim 11, in which the set of secondary processors are configured to wake from the low power mode in response to a secure inter-processor interrupt (IPI).

13. The processor-implemented method of claim 8, in which the cluster components firmware comprises power and clock management for the set of secondary processors.

14. The processor-implemented method of claim 8, further comprising enabling the set of secondary processors independently without a request from the primary processor.

15. An apparatus, comprising:
means for executing a cold boot process for a primary processor of multiple processors;
means for enabling the primary processor and cluster components firmware for supporting the multiple processors;
means for enabling a set of secondary processors of the multiple processors for software instruction fetching; and
means for configuring the set of secondary processors of the multiple processors to start execution of software instructions from a temporary wrapper.

16. The apparatus of claim 15, further comprising means for executing the cold boot process concurrently with execution of an extended boot loader for authentication for firmware images and initialization of trusted firmware routines by the primary processor.

17. The apparatus of claim 15, in which the temporary wrapper comprises a low power mode.

18. The apparatus of claim 17, further comprising:
means for waking the set of secondary processors from the low power mode; and
means for scheduling execution of software instructions by at least one secondary processor of the set of secondary processors.

19. The apparatus of claim 18, in which the set of secondary processors are configured to wake from the low power mode in response to a secure inter-processor interrupt (IPI).

20. The apparatus of claim 15, further comprising means for enabling the set of secondary processors independently without a request from the primary processor.
